(19) United States
(12) Patent Application Publication
(10) Pub. No.: US 2003/0223847 A1
(43) Pub. Date: Dec. 4, 2003

(54) Lift-stix, an all-terrain vehicle lift

(76) Inventors: Robert Wayne Crider, Des Arc, AR (US); Michael Douglas Crider, Trumann, AR (US)

Correspondence Address: Robert W. Crider, Rt. 2, Box 109-C, Des Arc, AR, 72040, US

(21) Appl. No.: 10/120,930

(22) Filed: Jun. 4, 2002

(51) Int. Cl. B60P 1/00

(52) U.S. Cl. 414/438

(57) ABSTRACT

To be used with an all-terrain vehicle (ATV), a lift comprised of two mounting brackets attached to the ATV, two telescoping side arms attached to the mounting brackets, a pivot arm attached to the two side arms, a lift-leg attached to the pivot arm, and a stabilizer bar attached to the lift-leg which will lift a load when the ATV is powered forward for a distance. After the load is slid onto the rack of the ATV, the lift is disassembled and collapses into a small enough configuration to allow it to be placed into a carrying case thus making it compact and very convenient for single use applications.

### CROSS REFERENCE TO RELATED APPLICATIONS

| | | | |
|---|---|---|---|
| 0538627 | Apr., 1895 | Shanks | 414/438 |
| 4806063 | Feb., 1989 | York | 414/462 |
| 5662451 | Sep., 1997 | Muzzi et al. | 414/462 |
| 5911556 | Jun., 1999 | Caldwell | 414/462 |

### BACKGROUND OF THE INVENTION

1. Field of the Invention

The present invention is a machine used to lift a load when attached to the rack of an all-terrain vehicle.

2. Description of Prior Art

All-terrain vehicles (ATV) are widely being used on farms, ranches, remote work sites, and for recreation and sporting where an aid to lift a load onto the rack of the vehicle is needed. A machine that can be attached only as needed, easily, quickly, and is lightweight and compact for carrying and storage, would be very useful. Adding to the value of such a machine would be the ability to universally mount to any ATV rack, independent of make or model. Prior art shows a lift that is manufactured as a unit and meant to be mounted to an ATV for extended periods of time, due to it's bulkiness and effort needed in mounting. It does not lend itself to quick mounting and unmounting for a single use or for collapsing into a small configuration. Many, if not most, ATV users do not want such a lift mounted to their vehicle 100% of the time when actually needed less than 1% of the time. U.S. Pat. No. 5,911,556, issued to Caldwell, shows such a lift that is dependent on make and model of an ATV for insuring a proper mounting scheme for the lift. Caldwell does not show utilizing a limiting rod inside interchangeable telescoping arms with a folding foot piece, the use of two identical mounting brackets, or the collapsible/“take-down” design which enhances the universality of the lift. The above noted patent is not seen to describe the instant invention as claimed.

### SUMMARY OF THE INVENTION

The present invention is a lift for loading objects onto an ATV. It has two mounting brackets that stay attached to the top or bottom rail of the rear rack of an ATV. Two telescoping side arms, self-limiting in extension, are pivotally attached with lynch pins to said mounting brackets. A pivot bar, that is the receiver for the lift-leg, is pivotally attached and secured with lynch pins to the two side arms. A telescopically adjustable lift-leg is inserted into the receiver of the pivot bar. A stabilizer bar, for soft ground, is used in conjunction with the lift-leg.

The principal object of the present invention is to provide a means to lift objects onto an ATV that is lightweight, compact, and will fit in a case which allows for carrying only when needed. It is another object of the present invention to universally fit most, if not all, racks on any ATV. This allows for a less expensive, more “off-the-shelf” choice for ATV owners.

It is an object of this invention to provide improved characteristics in a machine that is easy to use, dependable, effective in its' purpose, and economical for consumers.

These objects of the present invention are apparent after review of the following drawings.

### BRIEF DESCRIPTION OF THE DRAWINGS

FIG. 1 is the plan view showing the assembled lift as it would be attached to an ATV rack from a top view.

FIG. 2 is a side elevation view showing the lift in relation to the ATV while in the down position.

FIG. 3 is a side elevation view depicting the motion of the lift to the up position.

FIG. 4 is a partial view of member 1 (M1), the side arms, in the extended position.

FIG. 5 is a partial view of (M1), the side arms, showing relationship of the internal limit rod.

FIG. 6 is a partial view showing internal and external views of (M1), the side arms, in the collapsed position.

FIG. 7 is a partial view showing frontal and top views of member 2 (M2), the pivot bar, pointing out the position and relationship of the lift-leg receiver.

FIG. 8 is a partial view of member 3 (M3), the lift-leg, in the extended position.

FIG. 9 is a partial view of (M3), the lift-leg, showing relationship of the internal limit rod.

FIG. 10 is a partial view of (M3), the lift-leg, showing internal and external views in the collapsed position.

FIG. 11 is a partial view of member 4 (M4), the stabilizer bar.

FIG. 12 is a partial view of internal limit rods.

FIG. 13 is a partial view of member 5 (M5), the mounting bracket, showing side, front, and top views.

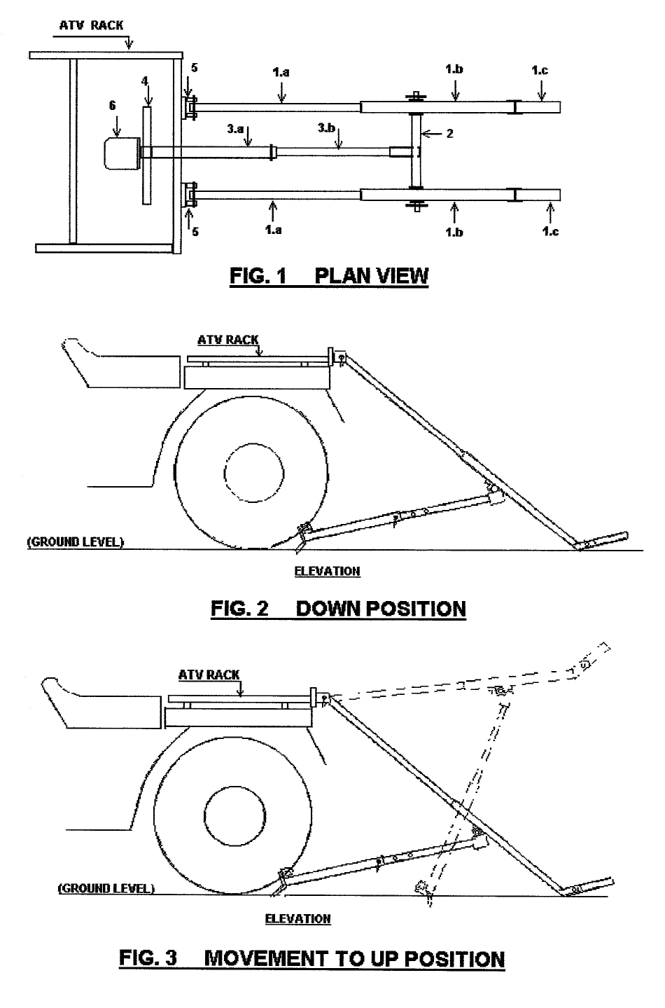

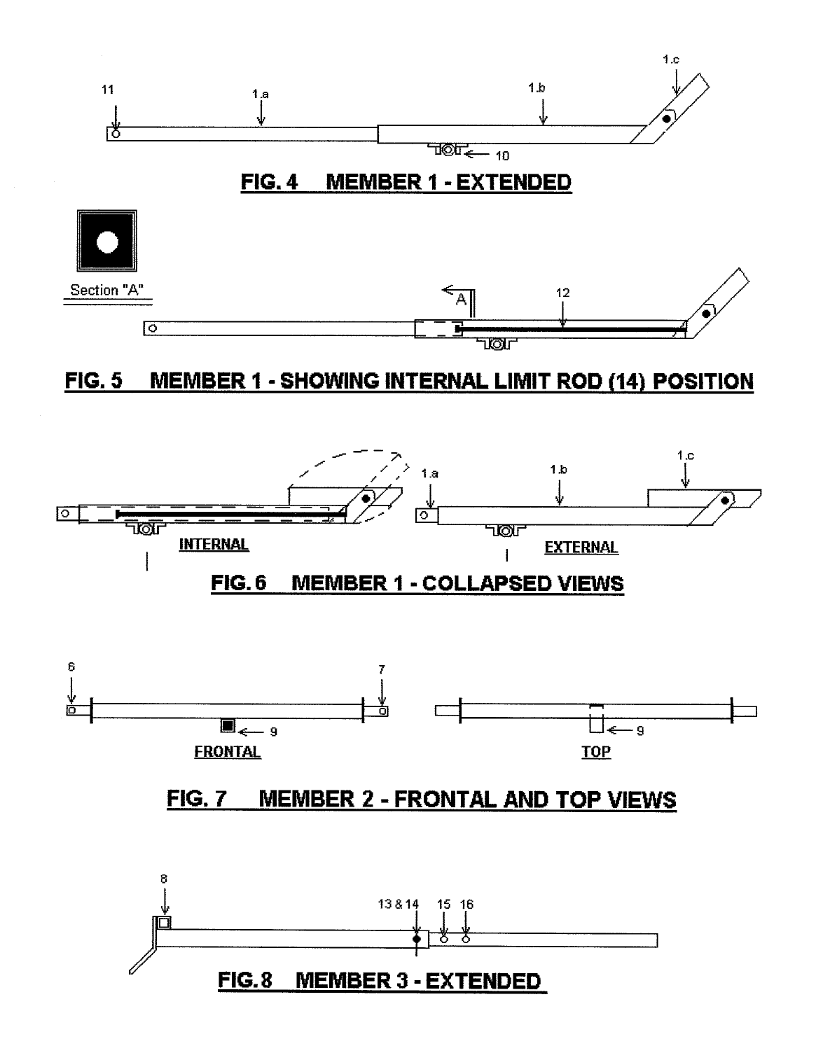

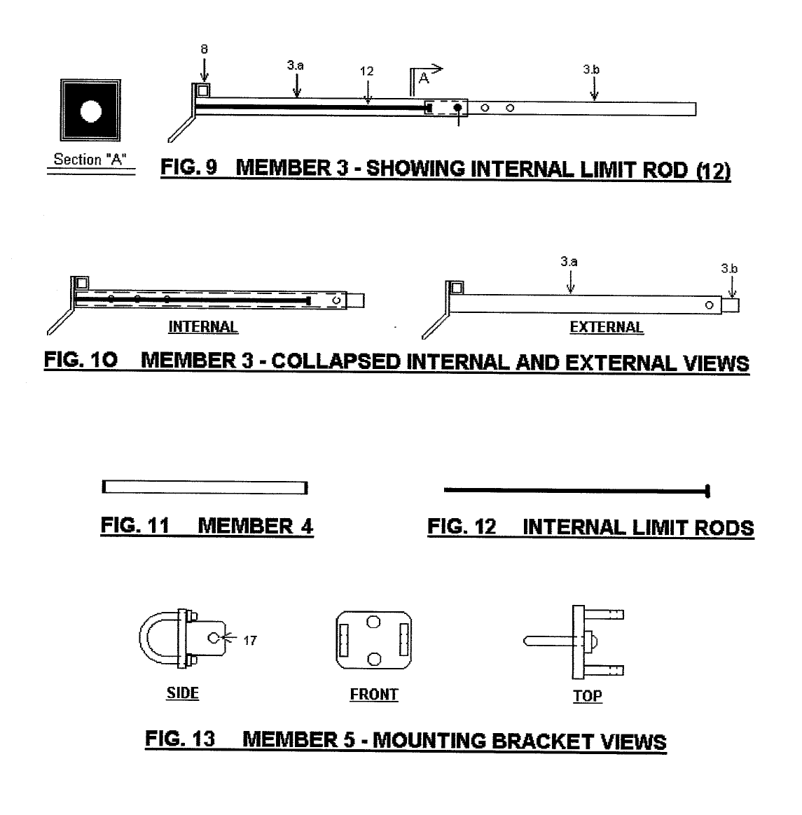

### DETAILED DESCRIPTION OF THE INVENTION

Referring to the drawings, the lift is comprised of two mounting brackets (M5), that attach to, and remain on, the top or bottom rail of the rear rack of an ATV. Two telescoping, self limiting, side arms (M1) comprised of; a slide tube (1.a), an outer tube (1.b), a folding foot (1.c), an internal limit rod (12), and a receiver bearing (10), attach to said brackets with lynch pins through aligning holes 11 and 17. A pivot arm (M2), that has a lift-leg receiver (9), attaches to the said two side arms through receiver bearings (10) and secured in place with lynch pins through holes (6) and (7). A lift-leg (M3), comprised of an outer tube (3.a) and a slide arm (3.b), that has a stabilizer bar receiver (8), attaches to the pivot arm (M2) by sliding the outer end of 3.b into the lift-leg receiver (9) and is adjustable for ATV height by aligning holes (13), of 3.a, and either (14), (15), or (16) of 3.b. A stabilizer bar (M4) slides into the receiver (8) on the lift-leg (M3) if conditions warrant. After assembling the lift and pivoting the folding feet (1.c) to their extended position, a load is placed across the bottom of the two side arms (M1) which will be resting on the ground. The folding feet (1.c), at the bottom of the side arms, help to hold the load in place while the lift begins. By driving the ATV slowly forward, the side arms (M1) will extend to their fully extended position which is limited by the internal limiting rods (12). At this time, the lift-leg (M3) is being pushed forward by the pivot arm (M2) and digs into the ground. With sufficient resistance against the ground, the lift-leg (M2) stops and begins pushing against the pivot arm (M2) causing the two side arms (M1) to rise. As the two side arms (M1) rise, the load is lifted to the desired height, as set by the lift-leg adjustment. At this point, the ATV is stopped and the load is slid onto the rack of the ATV. The lift can now be disassembled, placed in its' carrying case, and stored until the next time needed.

It is to be understood that the present invention is not limited to the embodiments described above, but encompasses any and all embodiments within the scope of the following claims.

I claim:

1. A lift for loading objects onto the rear rack of an all-terrain vehicle that is lightweight, collapsible, compact, and will store in a carrying case, said lift comprising;
two mounting brackets that attach to the rear rack of an all-terrain vehicle;
two telescoping side arms that pivotally attach to said mounting brackets;
a pivot arm attached pivotally to said side arms;
a telescopingly adjustable lift-leg attached to said pivot arm;
a stabilizer bar attached to said lift-leg.

2. The lift according to claim 1, wherein said side arms and lift-leg are self limiting in extension by use of an internal limiting rod.

3. The lift according to claim 1, can be disassembled and collapsed to fit in a carrying case.

4. The lift according to claim 1, has mounting brackets designed to universally fit the rear racks of all-terrain vehicles.

5. The lift according to claim 1, has a stabilizer bar to be used when conditions warrant.
